(19) United States
(12) Patent Application Publication
(10) Pub. No.: US 2006/0093443 A1
(43) Pub. Date: May 4, 2006

(54) Air transport device for plastic vessels equipped with a projecting collar

(76) Inventor: Lino Lanfranchi, Collecchio (Parma) (IT)

Correspondence Address: Shlesinger Fitzsimmons, Suite 1323, 183 East Main Street, Rochester, NY, 14604, US

(21) Appl. No.: 10/543,000

(22) PCT Filed: Jan. 29, 2004
(86) PCT No.: PCT/EP04/00507

§ 371 Date: Jul. 21, 2005

(30) Foreign Application Priority Data
Jan. 29, 2003 (IT) PR2003A000003

(51) Int. Cl. B65G 53/16

(52) U.S. Cl. 406/88

(57) ABSTRACT

The invention refers to the field of air transport systems for plastic vessels equipped with a projecting collar, and in particular refers to a device equipped with guides (10) and (11) for the vessel body (2) that provide for adjusting means (18) of the vertical guide position with respect to a sliding lane of the bottle collar and adjusting means (19) of the horizontal guide position with respect to the vertical vessel axis. The adjusting means can be simultaneously driven through a processor in which characteristic dimensional data of various vessels are entered.

The present invention deals with an air transport device for plastic vessels equipped with a projecting collar.

As known, the transport of plastic vessels equipped with a collar projecting from the bottle neck can be performed by means of air transport devices.

In this type of devices, see for example patent IT 1308585 of the same Applicant, the vessel is supported below the collar by two driving bars that create a sliding lane along which the vessel is pushed by air jets produced by fans arranged along the transfer path of the vessels themselves.

Below the sliding lane, vessel body guides are provided, assembled onto the same lane supporting structure, and whose development is substantially parallel to the vessel transfer path.

Purpose of said guides, a left one and a right one with respect to the vertical vessel axis, is avoiding the transverse oscillation of the vessel and keeping it vertical, such condition being mandatory for preventing the transport device from jamming.

It is obvious that the vertical guides position, with respect to the sliding lane, will depend on the vessel height, while the distance from the right guide with respect to the left guide will depend on the vessel diameter or on one of the transverse sizes in case of a vessel with a different section from the circular one or with an asymmetrical section with respect to the vertical axis.

Said air transport devices are mainly used to supply filling machines that are adapted to fill different types of vessels with different capacities and different shapes.

The guides must therefore be supported by means that allow approaching them or moving them apart, and also changing their position or distance from the sliding lane.

Every time the vessel or bottle format changes, it is therefore necessary to move the guides, such operation being currently performed manually by loosening and tightening some clamps.

In order to obviate the manual adjusting operation that requires quite a long time and therefore several machine stop hours, obviously depending on the transport path length, along the path many guides have been inserted, arranged at different heights and that can be horizontally moved through pneumatic actuators that take the guides to reach pre-established positions.

With the above-described arrangement, only the guides that can operate on the vessel body at a certain height of the vessel body itself are actuated.

The system of adopting a plurality of guides and actuate only those guides that are affected by such determined vessel format, in addition to be highly costly, allows a fixed and constant adjustment with horizontal guides movements of a pre-established and constant length

Shortly, with the known art, it is not possible to perform fine and variable adjustments depending on the vessels format change.

The known art allows performing adjustments for a number of formats that is limited, for example, to a maximum of two or three formats.

Another known system provides for oscillating the guides supporting bars in order to change their position with respect to the vertical sliding axis.

This system too has the same inconveniences of the previously-described prior art; moreover, in case of further additions for transporting vessels with different formats, it is often necessary to add a supplementary guide on the whole path with difficult access and registration, etc.

Object of the present invention is being able to automatically perform guides position adjustments depending on the vessel format to be transported, by further adopting only one guide for every vessel side, consequently reducing the air transport costs and practically doing without the machine stops for adapting the guides position depending on the vessel format.

A further object is making the transport device more accessible for possible checks and for its ordinary maintenance.

A further object is performing adjustments that allow adapting the guides for an unlimited number of vessel or bottle shapes both with symmetrical and with asymmetrical sections

Said object is filly reached by the air transport device for plastic vessels equipped with a projecting collar, object of the present invention, that is characterised by what is provided in the below-mentioned claims, and in particular in that it provides

This and other features will be better pointed out by the following description of a preferred embodiment shown, merely as a non-limiting example, in the enclosed table of drawing, in which:

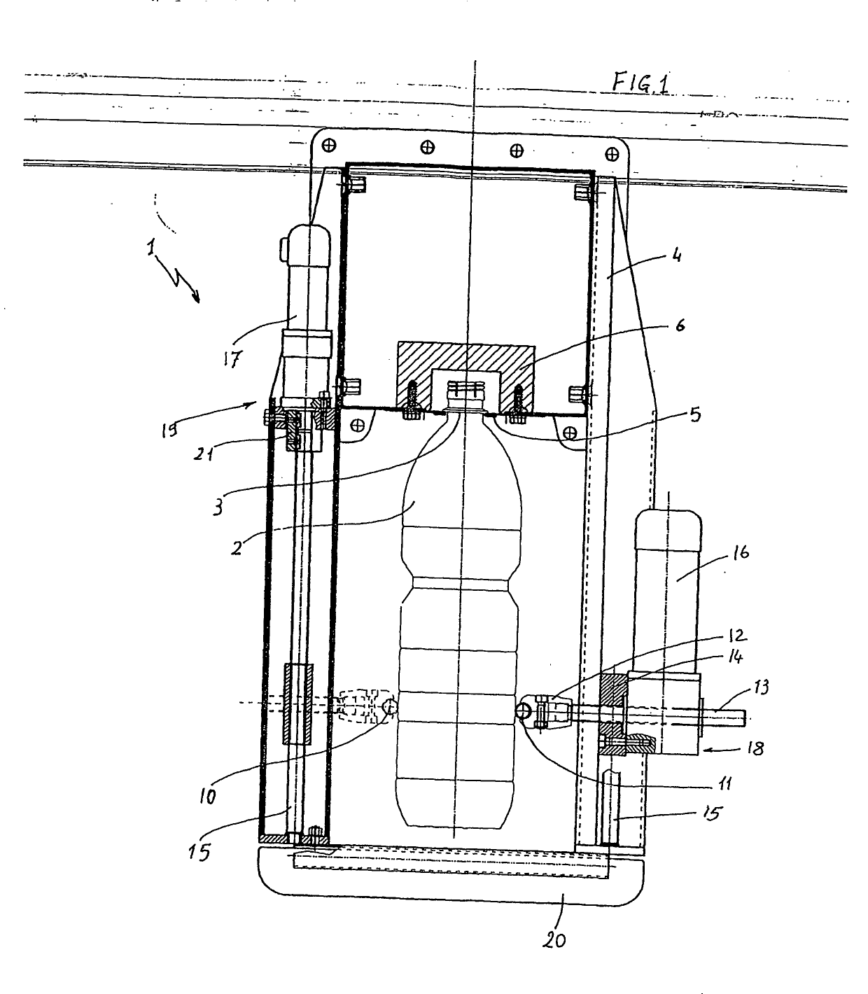

FIG. 1 shows the device according to a cross section on different planes;

FIG. 2 shows a part of the device according to section A-A in FIG. 1;

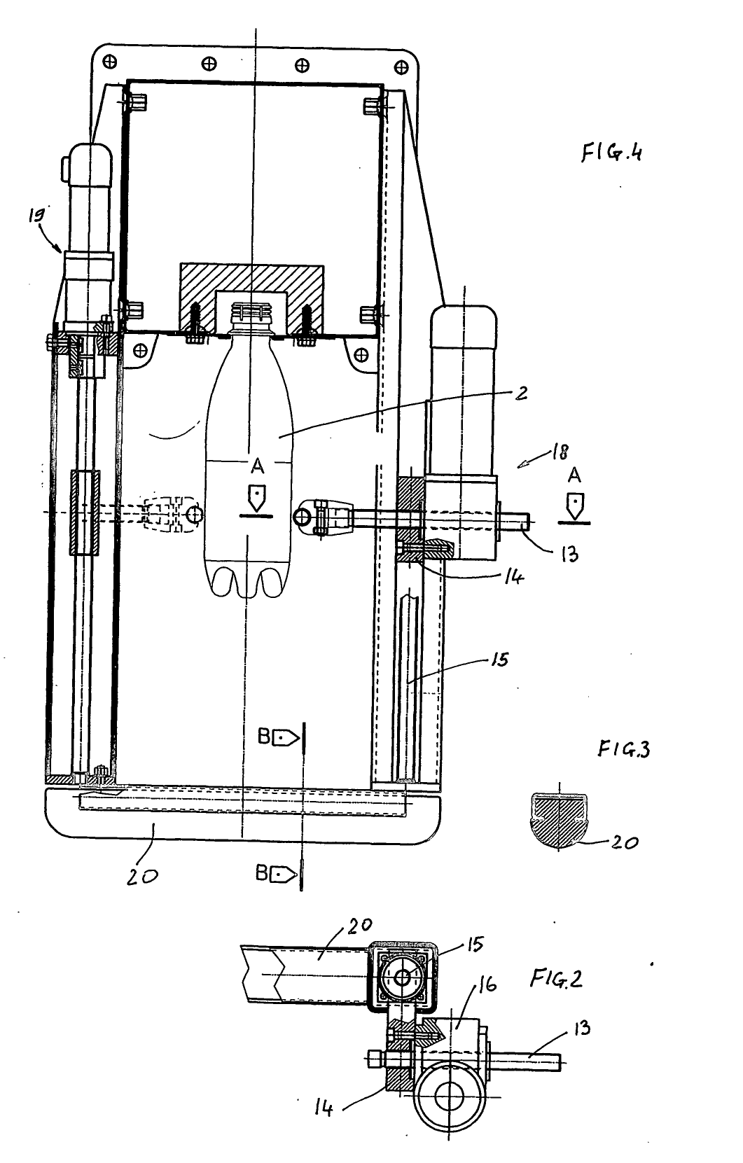

FIG. 3 shows a further part according to section B-B in FIG. 1;

FIG. 4 shows the device in the same view as of FIG. 1 with the guide bar position adjusted for smaller vessels.

With reference to FIG. 1, reference 1 globally points out an air transport device for vessels 2, particularly plastic bottles, equipped with a collar 3.

The above device comprises a supporting structure 4 realised through a frame that develops along the whole transfer path of the vessels themselves.

A lane 5 is secured onto the supporting structure 4, such lane interacting with the vessels collar 3, defining the transfer path. The lane 5 is realised through a bent sheet that creates a slit in which the neck is inserted for vessels whose bodies project under the lane.

Above the lane 5 a closure element 6, shaped as a reverse “U”, is provided. The device 1 is further equipped with means for pushing the vessels along their transfer path.

Said means, of a known type and not described in detail herein, are operatively associated with the supporting structure 4 and, in this case, are made of a plurality of fans arranged along the transfer path in a number that changes depending on the power of every fan and therefore on the thrust they manage to exert onto the vessel itself

What is defined as an air transport is thereby realised, that, in the area in which the vessel body travels, provides for at least two guiding bars 10 and 11 respectively placed on the right side and on the left side of the vessel.

Each guiding bar is supported by clamps 12 each one of which is integral with an horizontal threaded bar 13 sliding in a supporting block 14 in turn sliding along a vertical threaded bar 15.

A ratio-motor 16 is housed on the supporting block 14 and meshes with the horizontal threaded bar in order to rotatingly drag it and therefore to horizontally move the guiding bar, moving it away or near the vertical axis 9.

The vertical threaded bar 15 is rotated by a ratio-motor 17 connected to the bar through a joint 21 .

The ratio-motor 17 supply lowers or lifts the guiding bar 11.

Every guiding bar therefore provides for adjusting means 18 for its vertical position and for horizontal adjusting means 19 for its horizontal position. The adjusting means 19 for the horizontal movement can simultaneously intervene or not and perform different movements in case of vessels with asymmetrical section with respect to the vertical vessel axis, and also the vertical adjusting means 19 can simultaneously or separately intervene in order to perform equal or different movements; in fact, for vessels with the same capacity, different guiding bar positions can be necessary depending on the position of catching recesses or asymmetrical grooves.

According to a possible variation, not shown, for the vertical movement, a single ratio-motor could be used, and in such case the two vertical threaded bars will be connected from below through one horizontal shaft and two bevel gear pairs.

The channel where the bottle bodies slide is closed from below by a gasket 20 made of soft material in order not to create damages to operators passing near the transport device. The ratio-motors that perform the movements are supplied through a processor in which dimensional characteristics of the vessel are entered, and, depending on said characteristics, there will be an automatic intervention of all movement means arranged along the transport trajectory.

Preferably but not exclusively, two pairs of horizontal positioning means and two pairs of vertical positioning means will be arranged every 1-2 meters.

Every clamp 12 can support even two or more guiding bars in case of particularly high vessels or of vessels with particular outlines.

With the above-described device it is possible to carry out the simultaneous handling of all adjusting means inserted along the transport trajectory and therefore to adjust in a few seconds the position of the two or more guiding bars depending on the vessel sizes.

The adjusting means allows continuous and micrometric adjustments. The above-described air transport can be driven in sectors and therefore every sector will have its own control card.

1. Air transport device for plastic vessels equipped with a projecting collar and equipped with a sliding lane (5) that enters below the vessel collar and with guides (10) and (11) of the vessel body (2) placed in a sliding recess of said body, characterised in that it provides adjusting means (18) of the vertical guide position with respect to the sliding lane and adjusting means (19) of the horizontal guide position with respect to the vertical vessel axis or the sliding lane, said means being able to be simultaneously driven through a processor in which characteristic dimensional data of the various vessels to be transported are entered.

2. Air transport device according to claim 1, characterised in that it provides adjusting means (19) of the horizontal position of the guides (10) and (11) each one of which comprises a ratio-motor (16) meshing with an horizontal threaded bar (13) at one of whose ends a guide securing clamp is fixed, said adjusting means being supported by a block (14) that can translate vertically.

3. Air transport device according to claim 1, characterised in that it provides adjusting means (18) of the vertical position of the guides (10) and (11) comprising at least one ratio-motor (17) that rotates a vertical threaded bar (15) passing through the supporting block (14).

4. Air transport device according to claim 1, characterised in that it provides adjusting means for the vertical position comprising a single ratio-motor (17) for adjusting the vertical position of both guides, the two vertical threaded bars being connected through an horizontal shaft and two bevel gear pairs.

5. Air transport device according to clam 1, characterised in that it comprises a gasket (20) made of soft material that closes the channel in which the vessel bodies slide.
